(19) United States
(12) Patent Application Publication
(10) Pub. No.: US 2024/0194383 A1
(43) Pub. Date: Jun. 13, 2024

(54) Soft Magnetic Iron Alloy Plate, Method for Manufacturing Soft Magnetic Iron Alloy Plate, and Iron Core and Rotating Electric Machine Employing Soft Magnetic Iron Alloy Plate

(71) Applicant: Hitachi, Ltd., Chiyoda-ku, Tokyo (JP)

(72) Inventors: Matahiro KOMURO, Tokyo (JP); Tomohiro TABATA, Tokyo (JP); Shinya TAMURA, Tokyo (JP); Yusuke ASARI, Tokyo (JP); Shohei TERADA, Tokyo (JP)

(21) Appl. No.: 18/286,240

(22) PCT Filed: Feb. 18, 2022
(86) PCT No.: PCT/JP2022/006619

§ 371 Date: Oct. 10, 2023

(30) Foreign Application Priority Data
Apr. 26, 2021 (JP) 2021-074101

(51) Int. Cl. H01F 1/20; C21D 1/18; C21D 1/76; C21D 3/08; C21D 6/00; C21D 6/04; C21D 9/46; C22C 38/00; C22C 38/10

(52) U.S. Cl. CPC H01F 1/20; C21D 1/18; C21D 1/76; C21D 3/08; C21D 6/007; C21D 6/04; C21D 9/46; C22C 38/001; C22C 38/10; C21D 2211/008; C22C 2202/02

(57) ABSTRACT

A soft magnetic iron alloy plate having saturation magnetic flux density higher than that of an electromagnetic pure iron plate without an excessive increase in an iron loss, a method for manufacturing the soft magnetic iron alloy plate, and an iron core and a rotating electric machine using the soft magnetic iron alloy plate are provided. A soft magnetic iron alloy plate according to the present invention includes chemical composition containing 2 to 10 at. % of N, 0 to 30 at. % of Co, 0 to 1.2 at. % of V, and a remaining portion including Fe and impurities, and in a thickness direction of the soft magnetic iron alloy plate, an outer nitrogen concentration transition region where N concentration on a main surface is 1 to 4 at. % and N concentration increases toward the inner side from the main surface, a high nitrogen concentration region where maximum N concentration is higher than N concentration of the main surface and less than 11 at. %, and a variation range of N concentration is within 1 at. %, and an inner nitrogen concentration transition region where N concentration decreases toward the inner side from the high nitrogen concentration region and minimum N concentration is lower than N concentration in the high nitrogen concentration region and is 1 at. % or more.

### TECHNICAL FIELD

The present invention relates to a technique of a magnetic material, and particularly relates to a soft magnetic iron alloy plate having saturation magnetic flux density higher than that of an electromagnetic pure iron plate, a method for manufacturing the soft magnetic iron alloy plate, an iron core and a rotating electric machine using the soft magnetic iron alloy plate.

### BACKGROUND ART

An electromagnetic iron plate (for example, a thickness of 0.01 to 1 mm) such as an electromagnetic steel plate or an electromagnetic pure iron plate is a material used as an iron core of a rotating electric machine or a transformer by laminating and molding a plurality of sheets. In the iron core, it is important to have high conversion efficiency between electric energy and magnetic energy, and high magnetic flux density is important. In order to increase magnetic flux density, saturation magnetic flux density Bs of a material is desirably high, and an Fe—Co-based alloy material or an iron nitride material is known as an iron-based material having high Bs.

Further, cost reduction of an iron core is naturally one of most important problems, and technique development for stably and inexpensively manufacturing a material having high Bs has been actively conducted.

For example, PTL 1 (JP 2007-046074 A) discloses magnetic metal fine particles containing Fe as a main component, coated with graphite, having nitrogen content of 0.1 to 5 wt %, and containing at least one of Fe₄N and Fe₃N. Further, as a method for manufacturing the magnetic metal fine particles, there is disclosed a manufacturing method in which iron oxide powder and carbon-containing powder are mixed, the mixed powder is heat-treated in a non-oxidizing atmosphere to obtain metal fine particles coated with graphite mainly containing Fe, and the fine particles are further subjected to nitriding treatment to obtain the magnetic metal fine particles.

According to PTL 1, it is possible to provide magnetic metal fine particles having excellent corrosion resistance and a method for manufacturing the magnetic metal fine particles.

Further, PTL 2 (JP 2020-132894 A) discloses a soft magnetic material that is a plate-like or foil-like soft magnetic material having high saturation magnetic flux density, contains iron, carbon, and nitrogen, contains martensite containing carbon and nitrogen, and γ-Fe, and has a nitrogen-containing phase formed in the γ-Fe.

According to PTL 2, a soft magnetic material having saturation magnetic flux density exceeding that of pure iron and having thermal stability is manufactured at low cost, a characteristic of a magnetic circuit such as an electric motor is enhanced by of the soft magnetic material, and miniaturization, high torque, and the like of an electric motor and the like can be realized.

### CITATION LIST

### Patent Literatures

PTL 1: JP 2007-046074 A
PTL 2: JP 2020-132894 A

### SUMMARY OF INVENTION

### Technical Problem

A dust core is suitable for a relatively small electric component such as a noise filter and a reactor, but an iron core in which electromagnetic iron plates are laminated and molded is advantageous from the viewpoint of mechanical strength for a relatively large electric machine such as a rotating electric machine and a transformer. PTL 1 is considered to be a technique suitable for a dust core, but it cannot be said that the technique is suitable for manufacturing and using a thin plate material such as an electromagnetic iron plate.

Further, in order to improve conversion efficiency of electrical and magnetic energy in an iron core, a low iron loss Pi is also important in addition to high saturation magnetic flux density Bs. Pi is the sum of a hysteresis loss and an eddy current loss, and a coercive force Hc is desirably small in order to reduce a hysteresis loss. A magnetic characteristic of a commercially available electromagnetic pure iron plate is said to be Bs≈2.1 T and Hc≈80 A/m. The soft magnetic material of PTL 2 has an advantage of having higher Bs than that of an electromagnetic pure iron plate, but is considered to have a disadvantage in Hc.

Note that, from the viewpoint of high-output design in a rotating electric machine or a transformer, improvement of Bs of an iron core is more prioritized, and if degree of improvement of Bs is high, a certain increase in Pi is allowed.

Among currently commercialized soft magnetic bulk materials, Permendur (49Fe-49Co-2V mass %=50Fe-48Co-2V at. %, Bs=2.4 T) is well known as a material having highest Bs. However, material cost of Co fluctuates depending on the market, but is about 100 times higher than material cost of Fe, so that Permendur has a disadvantage that it is a very high-cost material. In other words, in a Fe—Co-based alloy material, if Co content is reduced, material cost can be reduced accordingly.

On the other hand, in recent years, a rotating electric machine (for example, a motor or a generator) having a small size and a high output has been strongly required, and improvement of a characteristic of an iron core is an urgent problem. Further, as described above, cost reduction of an iron core is naturally one of most important problems. For these reasons, there is a demand for a soft magnetic material that has Bs higher than that of an electromagnetic pure iron plate, has an increase in Pi within an allowable range, and is lower in cost than Permendur.

However, a technique for stably manufacturing a soft magnetic material exhibiting such a magnetic characteristic at low cost is not sufficiently established.

Therefore, an object of the present invention is to provide a soft magnetic iron alloy plate having saturation magnetic flux density higher than that of an electromagnetic pure iron plate without an excessive increase in an iron loss, a method for manufacturing the soft magnetic iron alloy plate, and an iron core and a rotating electric machine using the soft magnetic iron alloy plate.

### Solution to Problem

(I) One aspect of the present invention is a soft magnetic iron alloy plate including chemical composition containing 2 at. % or more and 10 at. % or less of nitrogen (N), 0 at. % or more and 30 at. % or less of cobalt (Co), 0 at. % or more and 1.2 at. % or less of vanadium (V), and a remaining portion including iron (Fe) and an impurity, and in a thickness direction of the soft magnetic iron alloy plate, an outer nitrogen concentration transition region where N concentration on a main surface is 1 at. % or more and 4 at. % or less and N concentration increases toward an inner side from the main surface, a high nitrogen concentration region where maximum N concentration is higher than N concentration of the main surface and less than 11 at. %, and a variation range of N concentration is within 1 at. % (within +0.5 at. %), and an inner nitrogen concentration transition region where N concentration decreases toward an inner side from the high nitrogen concentration region and minimum N concentration is lower than N concentration in the high nitrogen concentration region and is 1 at. % or more.

The present invention can add improvement and modification to the soft magnetic iron alloy plate (I) according to the present invention.

(i) Maximum N concentration in the high nitrogen concentration region is 6 at. % or more and 10 at. % or less, and minimum N concentration in the inner nitrogen concentration transition region is 1 at. % or more and 4 at. % or less.

(ii) An average N concentration gradient of the outer nitrogen concentration transition region is 0.1 at.%/μm or more and 0.6 at.%/μm or less, and an average N concentration gradient of the inner nitrogen concentration transition region is 0.1 at. %/μm or more and 0.3 at.%/μm or less.

(iii) When x is a numerical value of concentration (unit: at. %) of the Co, a numerical value y (unit: T) of saturation magnetic flux density of the soft magnetic iron alloy plate satisfies an empirical formula (1) “y≥1.02×(0.01×x+2.14)”, and when a numerical value of an iron loss (unit: W/kg) is z, an iron loss under a condition of magnetic flux density of 1.0 T and 400 Hz satisfies an empirical formula (2) “z<150×y−295”.

(iv) The soft magnetic iron alloy plate has a thickness of 0.03 mm or more and 0.3 mm or less.

(II) Another aspect of the present invention provides a method for manufacturing the soft magnetic iron alloy plate, the method including a starting material preparation step of preparing a starting material made from a soft magnetic material containing Fe as a main component and having a thickness of 0.03 mm or more and 0.3 mm or less, a nitrogen concentration distribution control heat treatment step of subjecting the starting material to predetermined nitrogen concentration distribution control heat treatment to form predetermined N concentration distribution along a thickness direction of the starting material, and a phase transformation and iron nitride phase generation step of subjecting the starting material in which the predetermined N concentration distribution is formed to martensite transformation and dispersing and generating an iron nitride phase. The predetermined nitrogen concentration distribution control heat treatment is heat treatment performed in an austenite phase forming temperature range, and is a combination of a nitrogen immersion process performed in predetermined ammonia gas atmosphere to infiltrate and diffuse N atoms from both main surfaces of the starting material and a nitrogen diffusion and denitrification process performed in predetermined nitrogen gas atmosphere to diffuse the N atoms further to an inner side of the starting material and to release nitrogen from both main surfaces of the starting material to form the outer nitrogen concentration transition region.

The present invention can add improvement and modification to the method (II) for manufacturing the soft magnetic iron alloy plate according to the present invention.

(v) The predetermined nitrogen concentration distribution control heat treatment is heat treatment of alternately performing a plurality of cycles of the nitrogen immersion process and the nitrogen diffusion and denitrification process.

(vi) The phase transformation and iron nitride phase generation step includes quenching for rapid cooling to lower than 100° C. and sub-zero treatment for cooling to 0° C. or less.

(III) According to still another aspect of the present invention, there is provided an iron core including a laminate of a soft magnetic iron alloy plate, in which the soft magnetic iron alloy plate is the soft magnetic iron alloy plate according to the present invention.

(IV) According to still another aspect of the present invention, there is provided a rotating electric machine including an iron core, in which the iron core is the iron core according to the present invention.

### Advantageous Effects of Invention

According to the present invention, a soft magnetic iron alloy plate having saturation magnetic flux density higher than that of an electromagnetic pure iron plate without an excessive increase in an iron loss and a method for manufacturing the soft magnetic iron alloy plate can be provided. Further, by using the soft magnetic iron alloy plate, it is possible to provide an iron core that is more advantageous for higher output of a rotating electric machine than an iron core using pure iron and a rotating electric machine.

### BRIEF DESCRIPTION OF DRAWINGS

FIG. 1 is a graph showing an example of a relationship between nitrogen concentration and a plate thickness direction length in a soft magnetic iron alloy plate according to the present invention.

FIG. 2 is a process drawing illustrating an example of a method for manufacturing the soft magnetic iron alloy plate according to the present invention.

FIG. 3A is a schematic perspective view illustrating an example of a stator of a rotating electric machine.

FIG. 3B is an enlarged cross-sectional schematic view of a slot region of the stator.

FIG. 4 shows an X-ray diffraction pattern of A-8 as a reference sample and A-1 as a sample of the present invention.

### DESCRIPTION OF EMBODIMENTS

### [Basic Idea of Present Invention]

Pure iron is advantageous in that it is inexpensive and has high saturation magnetic flux density Bs (2.1 T). An Fe—Si-based alloy to which silicon (Si) is added in an amount of about 1 to 3 mass % has an iron loss Pi that can be made lower than that of pure iron, but has a disadvantage that Bs is slightly lower (2.0 T). Further, Permendur containing about 50 mass % of Co shows sufficiently higher Bs (2.4 T) and a lower Pi than those of pure iron, but has a disadvantage that material cost of Co is much higher than that of Fe.

On the other hand, examples of a soft magnetic material exhibiting Bs higher than that of pure iron include the above-described iron nitride phase (for example, Fe₈N phase (α′ phase) and Fe₁₆N₂ phase (α″ phase)). The present inventors have paid attention to a technique (for example, PTL 2) in which Bs is improved when N is infiltrated and diffused into a soft magnetic material containing Fe as a main component to generate an α′-phase or α″-phase iron nitride phase. However, the soft magnetic material of PTL 2 has an advantage of having higher Bs than that of an electromagnetic pure iron plate, but is considered to have a disadvantage in Hc.

In view of the above, the present inventors have intensively studied a method for stably manufacturing a N-containing soft magnetic iron alloy plate showing Bs more excellent than that of an electromagnetic pure iron plate without excessively increasing Pi (with an increase in Pi within an allowable range in designing a rotating electric machine). As a result, the present inventors have found that when a starting material is subjected to predetermined nitrogen concentration distribution control heat treatment combining a nitrogen immersion process and a nitrogen diffusion and denitrification process so as to have predetermined N concentration distribution along a plate thickness direction, and then subjected to predetermined phase transformation and iron nitride phase generation treatment, a soft magnetic iron alloy plate having Bs higher than that of pure iron can be stably manufactured without an excessive increase in Pi. The present invention has been completed by the above finding.

Hereinafter, an embodiment according to the present invention will be described more specifically with reference to the drawings. However, the present invention is not limited to the embodiment described herein, and can be appropriately combined with or improved on the basis of a publicly-known technique without departing from the technical idea of the invention.

### [Soft Magnetic Iron Alloy Plate of Present Invention]

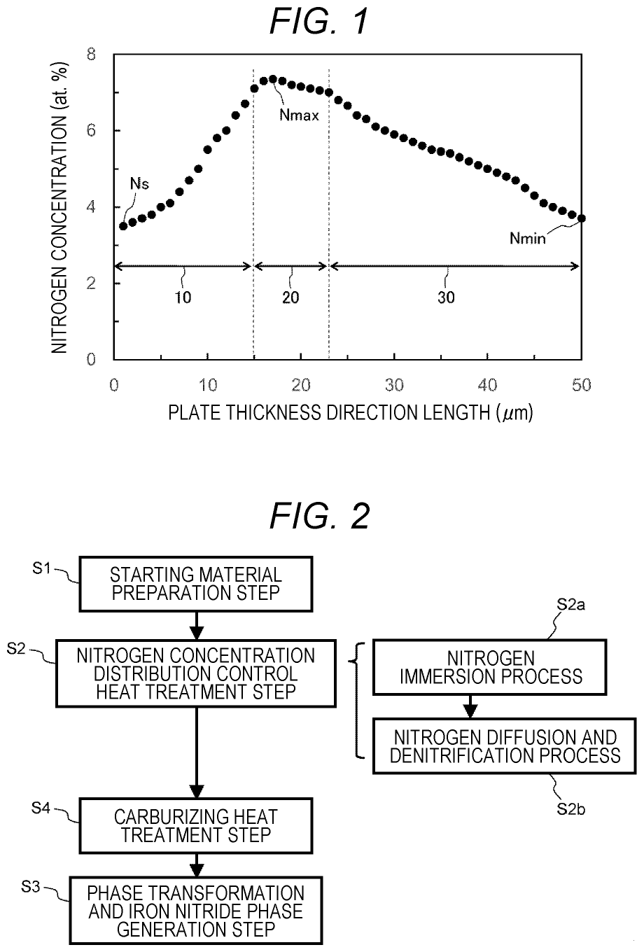

FIG. 1 is a graph showing an example of a relationship between nitrogen concentration and a plate thickness direction length in a soft magnetic iron alloy plate according to the present invention. The soft magnetic iron alloy plate illustrated in FIG. 1 is a sample having a thickness of 0.1 mm (100 μm), and “plate thickness direction length of 0 μm” in the diagram means one main surface of the iron alloy plate, and “plate thickness direction length of 50 μm” means the center of the iron alloy plate in the thickness direction. N concentration is obtained by performing quantitative analysis with a spot diameter of 1 μm using an electronic probe microanalyzer (EPMA, manufactured by JEOL Ltd., JXA-8800RL).

As illustrated in FIG. 1, the soft magnetic iron alloy plate of the present invention schematically has, in a thickness direction of the soft magnetic iron alloy plate, an outer nitrogen concentration transition region 10 in which N concentration increases inward from a main surface, a high nitrogen concentration region 20 in which maximum N concentration is higher than N concentration in the main surface and less than 11 at. %, and an inner nitrogen concentration transition region 30 in which N concentration is lowered inward from the high nitrogen concentration region 20. Since the soft magnetic iron alloy plate of the present invention has N atoms infiltrated and diffused from both main surfaces, N concentration distribution in the thickness direction is line-symmetric with a plate thickness center as an axis in principle.

More specific description will be made.

The high nitrogen concentration region 20 is a region where maximum N concentration is higher than N concentration of at least a main surface, and a variation range of N concentration is within 1 at. % (within ±0.5 at. %). The maximum N concentration is preferably 2 at. % or more and less than 11 at. %, more preferably more than 4 at. % and 10.5 at. % or less, still more preferably 6 at. % or more and 10 at. % or less. By setting the maximum N concentration to 2 at. % or more, it is considered that an iron nitride phase (Fe₈N phase (a′ phase) and/or Fe₁₆N₂ phase (α″ phase)) having a tetragonal structure is generated in an effective amount (for example, 10% by volume or more), which contributes to improvement of Bs of a soft magnetic iron alloy plate. On the other hand, by controlling the maximum N concentration to be less than 11 at. %, it is possible to prevent generation of an undesired iron nitride phase (for example, Fe₄N phase (γ′ phase) or Fe₃N phase (ε phase)) that does not contribute to improvement of Bs.

Thickness (plate thickness direction length) of the high nitrogen concentration region 20 is not particularly limited, but is preferably 3 μm or more, and more preferably 5 μm or more from the viewpoint of improving Bs. Further, from the viewpoint of ease of N concentration control, the thickness is preferably 20 μm or less, and more preferably 15 μm or more.

In an iron nitride phase (α′ phase and/or α″ phase) having a tetragonal structure, distortion of a crystal lattice due to infiltration of an N atom contributes to improvement of Bs. On the other hand, the α′ phase and the α″ phase have a disadvantage that Hc tends to be large and Pi tends to be large due to an increase in magneto crystalline anisotropy.

In view of the above, in the soft magnetic iron alloy plate of the present invention, the outer nitrogen concentration transition region 10 and the inner nitrogen concentration transition region 30 having relatively low N concentration are intentionally formed adjacent to the high nitrogen concentration region 20 to cause magnetic coupling between the high nitrogen concentration region 20 and the outer nitrogen concentration transition region 10 and magnetic coupling between the high nitrogen concentration region 20 and the nitrogen concentration transition region 30, so as to prevent an excessive increase in Pi of the soft magnetic iron alloy plate as a whole.

The outer nitrogen concentration transition region 10 is a region having concentration distribution in which N concentration gradually increases from a main surface toward the high nitrogen concentration region 20. N concentration of the main surface is preferably 1 at. % or more and 4 at. % or less, and more preferably 2 at. % or more and less than 4 at. %. When N concentration of the main surface is less than 1 at. %, a region near the main surface cannot sufficiently contribute to the purpose of improving Bs. When N concentration of the main surface is more than 4 at. %, influence of magneto crystalline anisotropy (increase in Pi) by the α′ phase and the α″ phase cannot be ignored.

An average N concentration gradient of the outer nitrogen concentration transition region 10 is preferably 0.1 at. %/μm or more and 0.6 at. %/μm or less, and more preferably 0.2 at. %/μm or more and less than 0.6 at. %/μm. When the average N concentration gradient is less than 0.1 at. %/μm, it is difficult to overcome potential of magnetization fixation due to magneto crystalline anisotropy. When the average N concentration gradient exceeds 0.6 at. %/μm, the gradient becomes steep, and magnetic coupling hardly occurs.

A thickness of the outer nitrogen concentration transition region 10 is also not particularly limited, but is preferably 5 μm or more and 30 μm or less, and more preferably 10 μm or more and 25 μm or less from the viewpoint of ease of N concentration control.

The inner nitrogen concentration transition region 30 is a region where N concentration gradually decreases from the high nitrogen concentration region 20 toward a plate thickness center. Minimum N concentration is lower than at least N concentration in the high nitrogen concentration region 20, and is preferably 1 at. % or more and 4 at. % or less, and more preferably 2 at.% or more and less than 4 at. %. When the minimum N concentration is less than 1 at. %, a region near the plate thickness center cannot sufficiently contribute to the purpose of improving Bs. When the minimum N concentration is more than 4 at. %, influence of magneto crystalline anisotropy (increase in Pi) by the α′ phase and the α″ phase cannot be ignored.

An average N concentration gradient of the inner nitrogen concentration transition region 30 is preferably 0.1 at. %/μm or more and 0.3 at. %/μm or less, and more preferably more than 0.1 at. %/μm and 0.2 at. %/μm or less. When the average N concentration gradient is less than 0.1 at.%/μm, a difference between adjacent magnetic domains is small, and propagation of a magnetization state becomes weak. When the average N concentration gradient exceeds 0.3 at. %/μm, the minimum N concentration tends to be less than 1 at. % in a region near the plate thickness center.

Note that, although a specific example will be described later, from a result of wide-angle X-ray diffraction (WAXD) measurement, it is considered that the entire soft magnetic iron alloy plate does not become the α′ phase and/or the α″ phase due to infiltration and diffusion of a N atom, and is in a state where an α phase (ferrite phase, body-centered cubic crystal) is a main phase (phase having a highest volume ratio), and the α′ phase and/or the α″ phase is dispersively generated. Further, since a γphase (austenite phase, face-centered cubic crystal) is close to nonmagnetic, when a volume ratio of the γphase exceeds 5%, a volume ratio of the α phase is reduced and it becomes difficult to improve Bs. A volume ratio of the γphase is more preferably 3% or less, and more preferably 1% or less.

Composition of the soft magnetic iron alloy plate is not particularly limited except that Fe is a main component (a component having maximum content) and N is contained, and a soft magnetic material (for example, an electromagnetic pure iron plate, an Fe—Co alloy material, an Fe—Si alloy material) that can be easily obtained industrially and commercially can be appropriately used as a thin plate material.

An electromagnetic pure iron plate is one of most inexpensive starting materials.

As an Fe—Co alloy material, an alloy containing Fe as a main component and Co in an amount of more than 0 at. % and 30 at. % or less can be suitably used. By setting Co content to 30 at. % or less, material cost can be greatly reduced as compared with Permendur. Co content is more preferably 3 at. % or more and 25 at. % or less, still more preferably 5 at. % or more and 20 at. % or less. Although not an essential component, V may be further contained within 4% of Co content (for example, when Co=30 at. %, V≤1.2 at. %).

Further, as an Fe—Si alloy material, an alloy containing Fe as a main component and Si in an amount of more than 0 at. % and 3 at. % or less can be suitably used.

Impurities (impurities that may be included in a starting material, for example, hydrogen (H), boron (B), carbon (C), phosphorus (P), sulfur (S), chromium (Cr), manganese (Mn), nickel (Ni), copper (Cu), and the like) are allowed as long as the impurities do not particularly adversely affect Bs of the soft magnetic iron alloy plate (for example, total concentration is within 2 at. %).

When nitrogen concentration distribution defined in the present invention is formed on the basis of these soft magnetic materials, Bs higher than that of the soft magnetic material as a base can be achieved. For example, in a case where an electromagnetic pure iron plate is used as a starting material, Bs exceeding 2.14 T can be achieved.

A thickness of the soft magnetic iron alloy plate is not particularly limited, and can be appropriately selected within a range of 0.01 mm or more and 1 mm or less, but from the viewpoint of controllability of N concentration distribution, the thickness is preferably 0.03 mm or more and 0.3 mm or less, and more preferably 0.05 mm or more and 0.2 mm or less.

Here, an allowable range of Pi in designing a rotating electric machine will be briefly described. As described above, from the viewpoint of high-output design in a rotating electric machine or a transformer, improvement of Bs of an iron core is more prioritized, and if degree of improvement of Bs is high, a certain increase in Pi is allowed.

From a large number of experiments by the present inventors, it has been found that clear characteristic improvement and a significant difference are considered to be obtained when Bs is improved by 2% or more as compared with Bs of the soft magnetic material as a base. Further, it has been empirically found that, when a numerical value (unit: T) of Bs of a soft magnetic material is “y” and a numerical value of Pi (unit: W/kg) under conditions of magnetic flux density of 1.0 T and 400 Hz is “z”, if an empirical formula “z<150×y−295” is satisfied, it is possible to design a rotating electric machine to have a high output.

### [Method for Manufacturing Soft Magnetic Iron Plate of Present Invention]

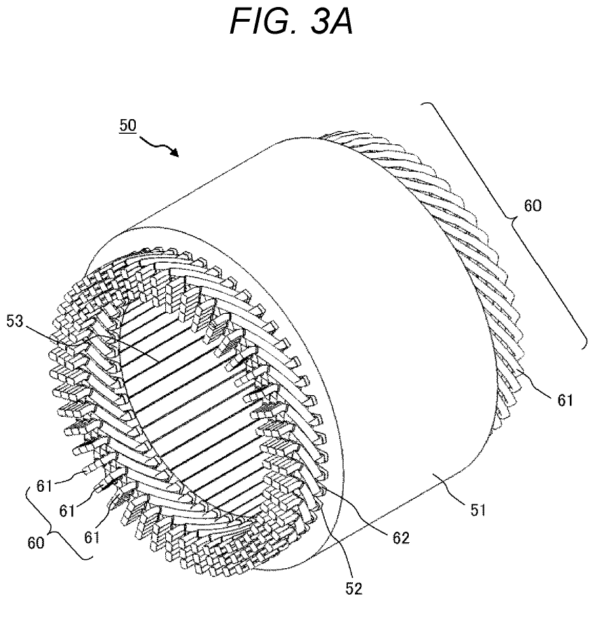

FIG. 2 is a process drawing illustrating an example of a method for manufacturing the soft magnetic iron alloy plate according to the present invention. As illustrated in FIG. 2, the method for manufacturing the soft magnetic iron alloy plate of the present invention schematically includes a starting material preparation step S1, nitrogen a concentration distribution control heat treatment step S2, and a phase transformation and iron nitride phase generation step S3. The carburizing heat treatment step S4 may be further performed between Step S2 and Step S3. Hereinafter, each step will be described more specifically.

### (Starting Material Preparation Step)

In present Step S1, a thin plate material (for example, a thickness of 0.03 to 0.3 mm) of a soft magnetic material is prepared as a starting material. There is no particular limitation as long as the soft magnetic material contains iron as a main component, and for example, an electromagnetic pure iron material, an Fe—Co alloy material, or an Fe—Si alloy material can be suitably used. As described above, in a case of an Fe—Co alloy material, an Fe—Co alloy material containing Co in an amount of more than 0 at. % and 30 at. % or less is preferable. In a case of an Fe—Si alloy material, an Fe—Si alloy material containing Si in an amount of more than 0 at. % and 3 at. % or less is preferable. Since these soft magnetic materials have low C content, it is relatively easy to control N concentration distribution in a starting material in a subsequent step, and this contributes to reduction in process cost.

### (Nitrogen Concentration Distribution Control Heat Treatment Step)

Present Step S2 is a step of applying predetermined nitrogen concentration distribution control heat treatment (heat treatment combining a nitrogen immersion process S2a and a nitrogen diffusion and denitrification process S2b) to a starting material to form predetermined nitrogen concentration distribution along a plate thickness direction of a starting material. The manufacturing method of the present invention has a significant characteristic in Step S2.

In the nitrogen immersion process S2a, N atoms are infiltrated and diffused from both main surfaces of a starting material under an environment of a temperature of 500° C. or higher (for example, an austenite phase (γphase) generation temperature region) and a predetermined ammonia (NH₃) gas atmosphere so that N concentration in a surface layer region (substantially, a region corresponding to the outer nitrogen concentration transition region 10) of the starting material becomes predetermined concentration. As the NH₃ gas atmosphere, mixed gas of NH₃ gas and N₂ gas, mixed gas of NH₃ gas and Ar gas, or mixed gas of NH₃ gas and H₂ gas can be suitably used. N concentration in a surface layer region of a starting material can be controlled mainly by controlling NH₃ gas partial pressure. Control of thickness (plate thickness direction length) of the surface layer region can be performed mainly by controlling temperature and time.

Introduction of NH₃ gas is preferably performed after temperature reaches 500° C. or higher. This is because when NH₃ gas is actively introduced in a stable temperature range of a ferrite phase (a phase), an undesired iron nitride phase (for example, an Fe₄N phase (γ′ phase) or an Fe₃N phase (ε phase)) is more likely to be generated rather than an iron nitride phase having a desirable tetragonal structure (an Fe₈N phase (α′ phase) and/or an Fe₁₆N₂ phase (α″ phase)).

Following the nitrogen immersion process S2a, the nitrogen diffusion and denitrification process S2b is performed. The process S2b is a process of reducing NH₃ gas partial pressure to zero while maintaining temperature of the process S2a, and is a process of further diffusing a part of N atoms infiltrated in the process S2a into the inside of a starting material, and simultaneously releasing a part of the infiltrated N atoms from a main surface of the starting material to reduce N concentration of the main surface. NH₃ gas partial pressure can be controlled, for example, by increasing partial pressure of carrier gas (N₂ gas, Ar gas, H₂ gas, and the like) at the time of the process S2a to compensate for NH₃ gas partial pressure.

By combining the nitrogen immersion process S2a and the nitrogen diffusion and denitrification process S2b, the outer nitrogen concentration transition region 10, the high nitrogen concentration region 20, and the inner nitrogen concentration transition region 30 are formed along a thickness direction of an iron alloy plate.

Further, by repeating, a plurality of cycles, combination f the process S2a and the process S2b (intermittently controlling time for supplying NH₃ gas and time for not supplying NH₃ gas), N concentration distribution (the outer nitrogen concentration transition region 10, the high nitrogen concentration region 20, and the inner nitrogen concentration transition region 30) inside an iron alloy plate can be more easily controlled.

### (Carburizing Heat Treatment Step)

Present Step S4 is heat treatment for infiltrating carbon into the outer nitrogen concentration transition region 10 formed in Step S2. Although Step S4 is not an essential step, by infiltrating C atoms into the outer nitrogen concentration transition region 10, an increase in Pi can be prevented without lowering Bs of the soft magnetic iron alloy plate.

A method of the carburizing heat treatment is not particularly limited, and a conventional method (for example, heat treatment under an acetylene (C₂H₂) gas atmosphere) can be suitably used. As an example, atmosphere gas can be changed to C₂H₂ gas following the nitrogen diffusion and denitrification process S2b.

### (Phase Transformation and Iron Nitride Phase Generation Step)

Present Step S3 is a step of performing quenching for rapid cooling to less than 100° C. for an iron alloy plate in which predetermined N concentration distribution is formed in Step S2 to cause phase transformation from the γphase to a martensite structure, and dispersing and generating an iron nitride phase (α′ phase and/or α″ phase) having a tetragonal structure. A quenching method is not particularly limited, and a conventional method (for example, water quenching and oil quenching) can be suitably used.

In order to transform a residual γphase in the iron alloy plate into a martensite structure, it is preferable to perform sub-zero treatment (for example, regular sub-zero treatment using dry ice, super-sub-zero treatment using liquid nitrogen) of cooling the iron alloy plate to 0° C. or less.

Further, although not an essential step, tempering at 100° C. or more and 210° C. or less may be further performed as necessary for the purpose of imparting toughness to a final soft magnetic iron alloy plate (not illustrated in FIG. 2).

### [Iron Core and Rotating Electric Machine Using Soft Magnetic Iron Alloy Plate of Present Invention]

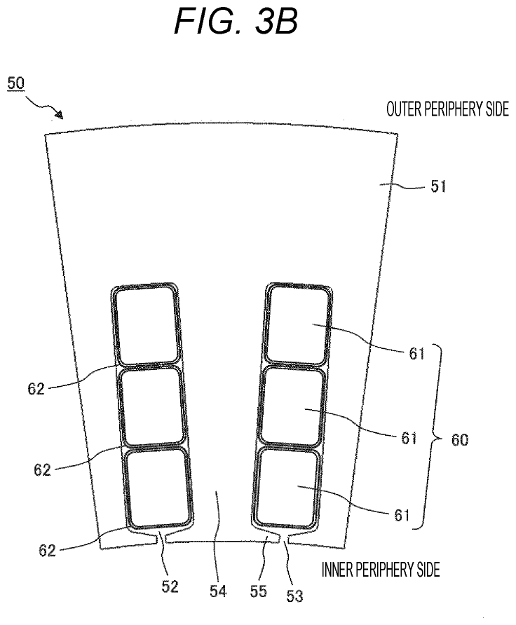

FIG. 3A is a schematic perspective view illustrating an example of a stator of a rotating electric machine, and FIG. 3B is a schematic enlarged transverse sectional view of a slot region of the stator. Note that the transverse section means a cross section orthogonal to a rotation axis direction (a cross section whose normal line is parallel to the axial direction). In the rotating electric machine, a rotor (not illustrated) is disposed on the inner side in a radial direction of the stator in FIGS. 3A to 3B.

As illustrated in FIGS. 3A to 3B, a stator 50 is formed by winding a stator coil 60 around a plurality of stator slots 52 formed on the inner peripheral side of an iron core 51. The stator slots 52 are spaces formed to be arrayed at a predetermined circumferential pitch in a circumferential direction of the iron core 51 and formed to penetrate in the axial direction, and a slit 53 extending in the axial direction is opened and formed in an innermost peripheral portion. A partitioning region of adjacent ones of the stator slots 52 is referred to as a tooth 54 of the iron core 51, and a portion defining the slit 53 in a tip region on the inner peripheral side of the tooth 54 is referred to as a tooth claw portion 55.

The stator coil 60 is usually composed of a plurality of segment conductors 61. For example, in FIGS. 3A to 3B, the stator coil 60 includes three of the segment conductors 61 corresponding to a U phase, a V phase, and a W phase of three-phase alternating current. Further, from the viewpoint of preventing partial discharge between the segment conductor 61 and the iron core 51 and partial discharge between each phase (U-phase, V-phase, and W-phase), an outer periphery of each of the segment conductors 61 is usually covered with an electrical insulating material 62 (for example, insulating paper and enamel coating).

An iron core and a rotating electric machine using the soft magnetic iron alloy plate of the present invention are the iron core 51 formed by laminating a large number of the soft magnetic iron alloy plates of the present invention molded into a predetermined shape in the axial direction, and a rotating electric machine using the iron core 51. Since the soft magnetic iron alloy plate of the present invention has Bs higher than that of an electromagnetic pure iron plate as described above, it is possible to provide an iron core having higher conversion efficiency between electric energy and magnetic energy than that of an iron core using a conventional electromagnetic pure iron plate or an electromagnetic steel plate. A highly efficient iron core leads to high torque and reduction in size of a rotating electric machine.

### EXAMPLE

Hereinafter, the present invention will be described more specifically by various experiments. However, the present invention is not limited to a configuration and a structure described in these experiments.

### Experiment 1

### (Preparation of Soft Magnetic Iron Alloy Plates A-1 to A-8)

As a starting material, a commercially available electromagnetic pure iron plate (thickness=0.1 mm) was prepared (Step S1). The starting material was subjected to nitrogen concentration distribution control heat treatment in which the starting material was heated to 1000° C. at a temperature rising rate of 15° C./min and held at 1000° ° C. for 2.5 hours while atmosphere control is performed (Step S2).

More specifically, NH₃ gas (partial pressure=1×10⁵ Pa) was introduced at a stage of reaching 500° C. in a temperature raising process, and at a stage of reaching 1000° ° C., the gas was switched to mixed gas of NH₃ gas (partial pressure=5×10⁴ Pa) and N₂ gas (partial pressure=4×10⁴ Pa) and held for 20 minutes (process S2a), and then only N₂ gas (pressure=9×10⁴ Pa) was switched and held for 5 minutes (process S2b). After the above, a total of six cycles of combination of the process S2a and the process S2b were performed, including holding with mixed gas for 20 minutes—holding with N₂ gas alone for 5 minutes, holding with mixed gas for 15 minutes—holding with N₂ gas alone for 10 minutes, holding with mixed gas for 10 minutes—holding with N₂ gas alone for 15 minutes, holding with mixed gas for 10 minutes—holding with N₂ gas alone for 15 minutes, holding with mixed gas for 10 minutes—holding with N₂ gas alone for 15 minutes.

Following the nitrogen concentration distribution control heat treatment described above, the starting material was subjected to oil quenching (60° C.) to undergo martensitic transformation, and then super-sub-zero treatment was performed to also undergo martensitic transformation of a residual γphase (Step S3). By the above, a sample A-1 of a soft magnetic iron alloy plate was prepared.

Next, samples A-2 to A-7 of soft magnetic iron alloy plates were prepared by using the same electromagnetic pure iron plate as described above as a starting material and variously changing time allocation of the process S2a and the process S2b. Further, the starting sample which was not subjected to Steps S2 to S3 was prepared as a sample A-8 (reference sample).

### Experiment 2

(Preparation of soft magnetic iron alloy plates B-1 to B-8).

Commercially available pure metal raw materials (Purity=99.9% for Fe and Co) were mixed, and an alloy ingot was prepared by an arc melting method (automatic arc melting furnace, manufactured by DIAVAC LIMITED, under reduced pressure Ar atmosphere) on water-cooled copper hearth. At this time, for alloy ingot homogenization, re-melting was repeated six times while the sample was reversed. The obtained alloy ingot was subjected to press working and rolling working to prepare a 95-at. %-Fe-5-at. %-Co alloy plate (thickness=0.1 mm) as a starting material (Step S1).

Next, Steps S2 to S3 were performed in the same manner as in Experiment 1 to prepare samples B-1 to B-7 of a soft magnetic iron alloy plate. Further, the starting sample which was not subjected to Steps S2 to S3 was prepared as a sample B-8 (reference sample).

### Experiment 3

(Preparation of soft magnetic iron alloy plates C-1 to C-8)

A 90-at. %-Fe-10-at. %-Co alloy plate (thickness=0.1 mm) as a starting material was prepared in the same manner as in Experiment 2 using a commercially available pure metal raw material (purity=99.9% for Fe and Co) (Step S1).

Next, Steps S2 to S3 were performed in the same manner as in Experiment 1 to prepare samples C-1 to C-7 of a soft magnetic iron alloy plate. Further, the starting sample which was not subjected to Steps S2 to S3 was prepared as a sample C-8 (reference sample).

### Experiment 4

(Preparation of soft magnetic iron alloy plates D-1 to D-8)

A 80-at. %-Fe-20-at. %-Co alloy plate (thickness=0.1 mm) as a starting material was prepared in the same manner as in Experiment 2 using a commercially available pure metal raw material (purity=99.9% for Fe and Co) (Step S1).

Next, Steps S2 to S3 were performed in the same manner as in Experiment 1 to prepare samples D-1 to D-7 of a soft magnetic iron alloy plate. Further, the starting sample which was not subjected to Steps S2 to S3 was prepared as a sample D-8 (reference sample).

### Experiment 5

(Investigation of properties of samples A-1 to A-8, B-1 to B-8, C-1 to C-8, and D-1 to D-8)

WAXD measurement using a Cu-Kα ray was performed on a cross section obtained by stacking 100 sheets of each of the obtained samples to identify a detection phase. As an X-ray diffractometer, Rint-Ultima III manufactured by Rigaku Corporation was used.

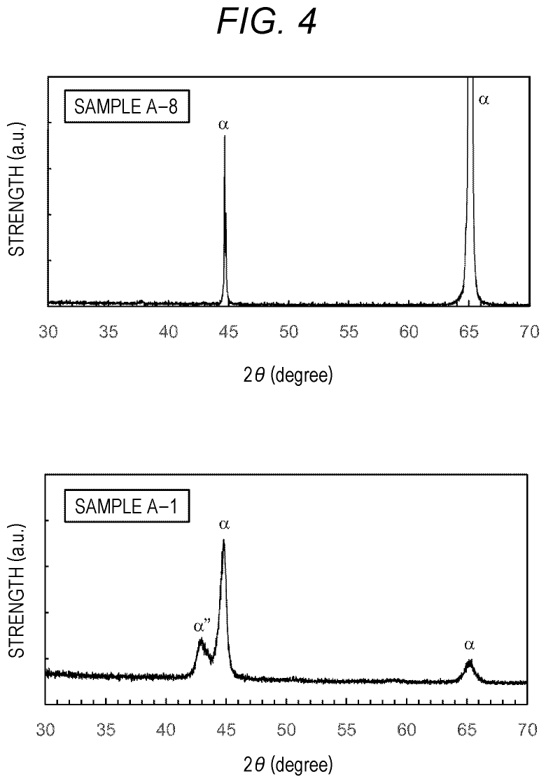

FIG. 4 shows an X-ray diffraction pattern of A-8 as a reference sample and A-1 as a sample of the present invention.

As illustrated in FIG. 4, in the reference sample A-8, only the α phase (ferrite phase) is confirmed. On the other hand, in the sample A-1 according to the present invention, the α″ phase (iron nitride phase of a tetragonal structure) is confirmed to be generated with the α phase as a main phase. The γphase (austenite phase) and the γ′ phase (Fe₄N phase) are not detected. Further, it was separately confirmed that the same result as that in FIG. 4 is obtained in other samples.

From these results, it is considered that in the soft magnetic iron alloy plate according to the present invention, an entire iron alloy plate does not become an iron nitride phase (α′ phase and/or α″ phase) having a tetragonal structure due to infiltration and diffusion of N atoms, but has a ferrite phase (α phase) as a main phase, and the α′ phase and/or the α″ phase is dispersed and generated.

Next, N concentration distribution in a plate thickness direction was investigated using EPMA on a cross section of each of the obtained samples. FIG. 1 shown above shows a result of A-1 as a sample of the present invention. As described above, the sample has N concentration distribution that can be classified into the outer nitrogen concentration transition region 10, the high nitrogen concentration region 20, and the inner nitrogen concentration transition region 30 in the plate thickness direction.

A measurement result of N concentration (Ns) on a main surface, maximum N concentration (Nmax) in the high nitrogen concentration region 20, minimum N concentration (Nmin) in the inner nitrogen concentration transition region 30, an average N concentration gradient (AGout) in the outer nitrogen concentration transition region 10, and an average N concentration gradient (AGin) in the inner nitrogen concentration transition region 30 for each sample are summarized in Table 1 described later.

Bs and Pi were measured as magnetic properties of each sample. Magnetization (unit: emu) of a sample was measured under conditions of a magnetic field of 1.6 MA/m and temperature of 20° C. using a vibrating sample magnetometer (VSM, BHV-525H of Riken Denshi Co., Ltd.), and Bs (unit: T) was determined from sample volume and sample mass. Further, Pi-_{1.0/400} (unit: W/kg) of a sample was measured under conditions of magnetic flux density of 1.0 T, 400 Hz, and temperature of 20° C. by an H coil method using a BH loop analyzer (IF-BH550 manufactured by IFG Corporation) and a vertical yoke single plate tester. A result of magnetic properties is also shown in Table 1.

TABLE 1
Result of investigation of properties of samples A-1
to A-8, B-1 to B-8, C-1 to C-8, and D-1 to D-8

| | Starting | | | | | | | |
|---|---|---|---|---|---|---|---|---|
| Sample | material | Ns | Nmax | Nmim | AGout | AGin | Bs | Pi |
| No. | (at %) | (at %) | (at %) | (at %) | (at %/μm) | (at %/μm) | (T) | (W/kg) |
| A-1 | Fe | 3.5 | 7.4 | 3.7 | 0.24 | 0.15 | 2.25 | 40 |
| A-2 | | 2 | 7.4 | 3.7 | 0.36 | 0.15 | 2.22 | 30 |
| A-3 | | 1 | 7.5 | 3.7 | 0.41 | 0.16 | 2.19 | 25 |
| A-4 | | 0.5 | 7.7 | 3.8 | 0.40 | 0.18 | 2.16 | 20 |
| A-5 | | 0 | 7.4 | 3.7 | 0.46 | 0.15 | 2.15 | 20 |
| A-6 | | 3.5 | 11 | 4 | 0.50 | 0.28 | 2.15 | 70 |
| A-7 | | 10 | 11.5 | 1 | 0.50 | 0.28 | 2.17 | 60 |
| A-8 | | 0 | 0 | 0 | 0.0 | 0.0 | 2.14 | 20 |
| B-1 | Fe—5%Co | 3 | 7.2 | 3.9 | 0.28 | 0.13 | 2.28 | 42 |
| B-2 | | 2 | 7.3 | 3.8 | 0.38 | 0.13 | 2.29 | 30 |
| B-3 | | 1 | 7.2 | 3.7 | 0.39 | 0.15 | 2.26 | 27 |
| B-4 | | 0 | 7.2 | 3.7 | 0.60 | 0.13 | 2.21 | 23 |
| B-5 | | 3 | 11.5 | 3 | 0.57 | 0.34 | 2.17 | 50 |
| B-6 | | 5 | 11 | 4 | 0.40 | 0.28 | 2.18 | 60 |
| B-7 | | 10.5 | 11 | 1 | 0.33 | 0.26 | 2.15 | 48 |
| B-8 | | 0 | 0 | 0 | 0.0 | 0.0 | 2.19 | 23 |
| C-1 | Fe—10%Co | 3.5 | 7.1 | 3.6 | 0.28 | 0.13 | 2.38 | 28 |
| C-2 | | 2 | 7.1 | 3.5 | 0.34 | 0.14 | 2.36 | 27 |
| C-3 | | 1 | 7.1 | 3.3 | 0.44 | 0.15 | 2.35 | 26 |
| C-4 | | 0 | 7.1 | 3.1 | 0.65 | 0.14 | 2.28 | 31 |
| C-5 | | 0 | 11 | 4 | 1.10 | 0.23 | 2.24 | 45 |
| C-6 | | 3.5 | 11.5 | 3 | 0.53 | 0.34 | 2.26 | 58 |
| C-7 | | 10.5 | 11 | 1 | 0.33 | 0.26 | 2.27 | 65 |
| C-8 | | 0 | 0 | 0 | 0.0 | 0.0 | 2.24 | 32 |
| D-1 | Fe—20%Co | 3.5 | 9.5 | 3.5 | 0.50 | 0.21 | 2.48 | 25 |
| D-2 | | 2 | 8.5 | 3.6 | 0.59 | 0.17 | 2.46 | 24 |
| D-3 | | 1 | 7.3 | 3.4 | 0.42 | 0.16 | 2.45 | 24 |
| D-4 | | 0 | 7.1 | 3.1 | 0.65 | 0.14 | 2.41 | 32 |
| D-5 | | 0 | 11 | 4 | 1.10 | 0.23 | 2.25 | 40 |
| D-6 | | 3.5 | 11 | 3.5 | 0.47 | 0.31 | 2.33 | 61 |
| D-7 | | 10 | 11 | 0.5 | 0.50 | 0.28 | 2.31 | 68 |
| D-8 | | 0 | 0 | 0 | 0.0 | 0.0 | 2.33 | 31 |

Ns: N concentration of main surface
Nmax: Maximum N concentration of high nitrogen concentration region
Nmin: Minimum N concentration of inner nitrogen concentration transition region
AGout: Average N concentration gradient of outer nitrogen concentration transition region
AGin: Average N concentration gradient of inner nitrogen concentration transition region

Each of the samples A-8, B-8, C-8, and D-8 is a reference sample as a starting material. Comparing Bs of the samples A-8, B-8, C-8, and D-8, it is found that Bs linearly increases with an increase in Co content.

As described above, from many experiments by the present inventors it has been found that a clear characteristic improvement and a significant difference can be considered to be obtained if Bs is improved by 2% or more as compared with Bs of a soft magnetic material as a base. In view of the above, in the present invention, when a numerical value of Co concentration (unit: at. %) in a starting material is x, in a case where a numerical value y (unit: T) of Bs of a soft magnetic iron alloy plate satisfies an empirical formula (1) “y≥1.02×(0.01×x+2.14)”, “improvement in Bs” is determined.

Further, it has been empirically found that, when a numerical value (unit: T) of Bs of a soft magnetic material is “y” and a numerical value of Pi (unit: W/kg) under conditions of magnetic flux density of 1.0 T and 400 Hz is “z”, if an empirical formula (2) “z<150×y−295” is satisfied, it is possible to design a rotating electric machine to have a high output. In view of the above, in the present invention, in a case where the empirical formula (2) “z<150×y−295” is satisfied, “Pi is not excessively increased/increase in Pi is within an allowable range” is determined.

Then, a case where both of the empirical formula (1) and the empirical formula (2) are satisfied is determined as “pass”, and the other cases are determined as “fail”.

When a result of Table 1 is viewed from this viewpoint, in each of the samples A-1 to A-3 having the outer nitrogen concentration transition region, the high nitrogen concentration region, and the inner nitrogen concentration transition region defined by the present invention, Bs is improved by 2% or more as compare with Bs of the reference sample A-8, and Pi satisfies the empirical formula (2). Similarly, in each of the samples B-1 to B-3, Bs is improved by 2% or more as compared with Bs of the reference sample B-8, and Pi satisfies the empirical formula (2). In each of the samples C-1 to C-3, Bs is improved by 2% or more as compared with Bs of the reference sample C-8, and Pi satisfies the empirical formula (2). In each of the samples D-1 to D-3, Bs is improved by 2% or more as compared with Bs of the reference sample D-8, and Pi satisfies the empirical formula (2).

In contrast to these, in each of the samples A-4 to A-5, B-4, B-6 to B-7, C-4 to C-5, C-7, D-4 to D-5, and D-7 deviating from the definition of the outer nitrogen concentration transition region of the present invention, Bs does not satisfy the empirical formula (1) (does not reach improvement of 2% of Bs of the reference sample). In each of the samples A-6 to A-7, B-5 to B-7, C-5 to C-7, and D-5 to D-7 deviating from the definition of the high nitrogen concentration region of the present invention, Pi does not satisfy the empirical formula (2). Further, in each of the samples A-7, B-7, C-7, and D-7 that deviate from the definition of the inner nitrogen concentration transition region of the present invention, Bs does not satisfy the empirical formula (1) (does not reach improvement of 2% of Bs of the reference sample).

In other words, it has been confirmed that the soft magnetic iron alloy plate having the outer nitrogen concentration transition region, the high nitrogen concentration region, and the inner nitrogen concentration transition region defined by the present invention exhibits higher Bs than an electromagnetic pure iron plate without excessive increase of Pi.

The above-described embodiments and experiments are described in order to help understanding of the present invention, and the present invention is not limited only to the specific configurations described. For example, a part of a configuration of the embodiment can be replaced with a configuration of a technical common sense of those skilled in the art, and a configuration of a technical common sense of those skilled in the art can be added to a configuration of the embodiment. That is, in the present invention, a part of a configuration of the embodiments and experiments of the present specification can deleted, with be replaced another configuration, or added with another configuration without departing from the technical idea of the invention.

### REFERENCE SIGNS LIST

10 outer nitrogen concentration transition region
20 high nitrogen concentration region
30 inner nitrogen concentration transition region
50 stator
51 iron core
52 stator slot
53 slit
54 tooth
55 tooth claw portion
60 stator coil
61 segment conductor
62 electrical insulating material

1. A soft magnetic iron alloy plate comprising:
chemical composition containing 2 at. % or more and 10 at. % or less of nitrogen, 0 at. % or more and 30 at. % or less of cobalt, 0 at. % or more and 1.2 at. % or less of vanadium, and a remaining portion including iron and an impurity; and
in a thickness direction of the soft magnetic iron alloy plate,
an outer nitrogen concentration transition region where nitrogen concentration on a main surface is 1 at. % or more and 4 at. % or less and nitrogen concentration increases toward an inner side from the main surface;
a high nitrogen concentration region where maximum nitrogen concentration is higher than nitrogen concentration of the main surface and less than 11 at. %, and a variation range of nitrogen concentration is within 1 at. %; and
an inner nitrogen concentration transition region where nitrogen concentration decreases toward an inner side from the high nitrogen concentration region and minimum nitrogen concentration is lower than N concentration in the high nitrogen concentration region and is 1 at. % or more.

2. The soft magnetic iron alloy plate according to claim 1, wherein
maximum nitrogen concentration in the high nitrogen concentration region is 6 at. % or more and 10 at. % or less, and
minimum nitrogen concentration in the inner nitrogen concentration transition region is 1 at. % or more and 4 at. % or less.

3. The soft magnetic iron alloy plate according to claim 1, wherein
an average nitrogen concentration gradient of the outer nitrogen concentration transition region is 0.1 at. %/μm or more and 0.6 at. %/μm or less, and
an average nitrogen concentration gradient of the inner nitrogen concentration transition region is 0.1 at. %/μm or more and 0.3 at. %/μm or less.

4. The soft magnetic iron alloy plate according to claim 1, wherein
when x is a numerical value of concentration (unit: at. %) of cobalt, a numerical value y (unit: T) of saturation magnetic flux density of the soft magnetic iron alloy plate satisfies an empirical formula (1) “y≥1.02×(0.01×x+2.14)”, and
when a numerical value of an iron loss (unit: W/kg) is z, an iron loss under a condition of magnetic flux density of 1.0 T and 400 Hz satisfies an empirical formula (2) “z<150×y−295”.

5. The soft magnetic iron alloy plate according to claim 1, wherein the soft magnetic iron alloy plate has a thickness of 0.03 mm or more and 0.3 mm or less.

6. A method for manufacturing the soft magnetic iron alloy plate according to claim 1, the method comprising:
a starting material preparation step of preparing a starting material made from a soft magnetic material containing iron as a main component and having a thickness of 0.03 mm or more and 0.3 mm or less;
a nitrogen concentration distribution control heat treatment step of subjecting the starting material to predetermined nitrogen concentration distribution control heat treatment to form predetermined nitrogen concentration distribution along a thickness direction of the starting material; and
a phase transformation and iron nitride phase generation step of subjecting the starting material in which the predetermined nitrogen concentration distribution is formed to phase transformation into a martensite structure and dispersing and generating an iron nitride phase, wherein
the predetermined nitrogen concentration distribution control heat treatment is heat treatment performed in an austenite phase forming temperature range, and is a combination of a nitrogen immersion process performed in predetermined ammonia gas atmosphere to infiltrate and diffuse nitrogen atoms from both main surfaces of the starting material and a nitrogen diffusion and denitrification process performed in predetermined nitrogen gas atmosphere to diffuse the nitrogen atoms further to an inner side of the starting material and to release nitrogen from both main surfaces of the starting material to form the outer nitrogen concentration transition region.

7. The method for manufacturing the soft magnetic iron alloy plate according to claim 6, wherein the predetermined nitrogen concentration distribution control heat treatment is heat treatment of alternately performing a plurality of cycles of the nitrogen immersion process and the nitrogen diffusion and denitrification process.

8. The method for manufacturing the soft magnetic iron alloy plate according to claim 6, wherein the phase transformation and iron nitride phase generation step includes quenching for rapid cooling to lower than 100° C., and sub-zero treatment for cooling to 0° C. or less.

9. An iron core comprising a laminate of a soft magnetic iron alloy plate, wherein the soft magnetic iron alloy plate is the soft magnetic iron alloy plate according to claim 1.

10. A rotating electric machine comprising an iron core, wherein the iron core is the iron core according to claim 9.

11. The soft magnetic iron alloy plate according to claim 2, wherein
an average nitrogen concentration gradient of the outer nitrogen concentration transition region is 0.1 at. %/μm or more and 0.6 at. %/μm or less, and
an average nitrogen concentration gradient of the inner nitrogen concentration transition region is 0.1 at. %/μm or more and 0.3 at. %/μm or less.

12. The soft magnetic iron alloy plate according to claim 2, wherein
when x is a numerical value of concentration (unit: at. %) of cobalt, a numerical value y (unit: T) of saturation magnetic flux density of the soft magnetic iron alloy plate satisfies an empirical formula (1) “y≥1.02×(0.01×x+2.14)”, and
when a numerical value of an iron loss (unit: W/kg) is z, an iron loss under a condition of magnetic flux density of 1.0 T and 400 Hz satisfies an empirical formula (2) “z<150×y−295”.

13. The soft magnetic iron alloy plate according to claim 3, wherein
when x is a numerical value of concentration (unit: at. %) of cobalt, a numerical value y (unit: T) of saturation magnetic flux density of the soft magnetic iron alloy plate satisfies an empirical formula (1) “y≥1.02×(0.01×x+2.14)”, and
when a numerical value of an iron loss (unit: W/kg) is z, an iron loss under a condition of magnetic flux density of 1.0 T and 400 Hz satisfies an empirical formula (2) “z<150×y−295”.

14. The soft magnetic iron alloy plate according to claim 11, wherein
when x is a numerical value of concentration (unit: at. %) of cobalt, a numerical value y (unit: T) of saturation magnetic flux density of the soft magnetic iron alloy plate satisfies an empirical formula (1) “y≥1.02×(0.01×x+2.14)”, and
when a numerical value of an iron loss (unit: W/kg) is z, an iron loss under a condition of magnetic flux density of 1.0 T and 400 Hz satisfies an empirical formula (2) “z<150×y−295”.

15. The method for manufacturing the soft magnetic iron alloy plate according to claim 7, wherein the phase transformation and iron nitride phase generation step includes quenching for rapid cooling to lower than 100° C., and sub-zero treatment for cooling to 0° C. or less.
